(19) United States
(12) Patent Application Publication
(10) Pub. No.: US 2013/0314197 A1
(43) Pub. Date: Nov. 28, 2013

(54) Magnetic Configuration for High Efficiency Power Processing

(71) Applicants: Ionel Jitaru, Tucson, AZ (US); Marco Antonio Davila, Tucson, AZ (US); Andrei Savu, Bucharest (RO); Andrei Ion Radulescu, Targoviste (RO)

(72) Inventors: Ionel Jitaru, Tucson, AZ (US); Marco Antonio Davila, Tucson, AZ (US); Andrei Savu, Bucharest (RO); Andrei Ion Radulescu, Targoviste (RO)

(21) Appl. No.: 13/887,346

(22) Filed: May 5, 2013

Related U.S. Application Data
(60) Provisional application No. 61/642,804, filed on May 4, 2012.

(51) Int. Cl. H01F 27/34

(52) U.S. Cl. CPC H01F 27/346
USPC 336/222

(57) ABSTRACT

Several new and useful features for a magnetic structure are provided. One feature is that the magnetic structures are configured to help minimize the winding's AC losses, improving the system's efficiency. Another feature is that the combination of different magnetic hats creates a shaping path for the magnetic field. Still another feature is that a magnetic hat concept can be applied to a variety of magnetic core shapes.

### RELATED APPLICATION/CLAIM OF PRIORITY

This application is related to and claims priority from U.S. Provisional application Ser. No. 61/642,804, entitled Magnetic configuration for High Efficiency Power Processing, filed May 4, 2012, which provisional application is incorporated herein by reference.

Power transformers are a fundamental component of a power supply. The efficiency of the transformer has a great impact on the total power converter's efficiency.

The AC resistance of the winding is a significant factor of increasing the conduction losses in a transformer. Severe proximity effects increase the AC resistance, Also if the windings are in the path of the magnetic field. the AC loss increases due to the fact that the field lines cut into the copper creating eddy currents.

AC losses increase when the air gap in the transformer increases, and when the winding is closer to the air gap. This is due to the fact that the magnetic field lines become perpendicular to the windings. The windings can be planar, copper wire, litz wire, all can be affected by this phenomena.

In the case of wireless/contactless power supplies or inductive power transfer(IPT) the transformer's air gap increases automatically compared to the conventional transformers. The magnetic field lines become perpendicular to the windings creating unwanted proximity effects.

This application is accompanied by FIGS. 1-16 which are reproduced and described in the description that follows.

### BRIEF DESCRIPTION OF THE DRAWINGS

FIG. 1 shows an arrangement of proposed circular pads;

FIG. 2 shows an arrangement of material and winding in a circular pot core;

FIG. 3 shows a proposed transformer design, involving increasing DC distance of the windings;

FIG. 4 shows a concept for low power wireless power systems;

FIG. 5 shows a first magnetic structure according to the present invention;

FIG. 6 shows a cross section of the primary side 3 of the magnetic structure of FIG. 5;

FIG. 7 shows a second magnetic structure according to the present invention;

FIG. 8 shows a cross section of the primary side 10 of the magnetic structure of FIG. 7;

FIG. 9 shows a third magnetic structure according to the present invention;

FIG. 10 shows a cross section of the primary side 18 of the magnetic structure of FIG. 9;

FIG. 11 shows a fourth magnetic structure according to the present invention;

FIG. 12 shows a cross section of the primary side 25 of the magnetic- structure of FIG. 11;

FIG. 13 shows a fifth magnetic structure according to the present invention;

FIG. 14 shows a cross section of the primary side 32 of the magnetic structure of FIG. 13;

FIG. 15 shows a sixth magnetic structure according to the present invention; and

FIG. 16 shows a cross section of the primary side 39 of the magnetic structure of FIG. 15,

### PRIOR ART

An investigation and analysis of circular pot cores is performed by John T. Boys and Grant A. Covic in [2], In their work there is no consideration of AC losses in the transformers, FIG. 1 shows their arrangement of their proposed circular pads.

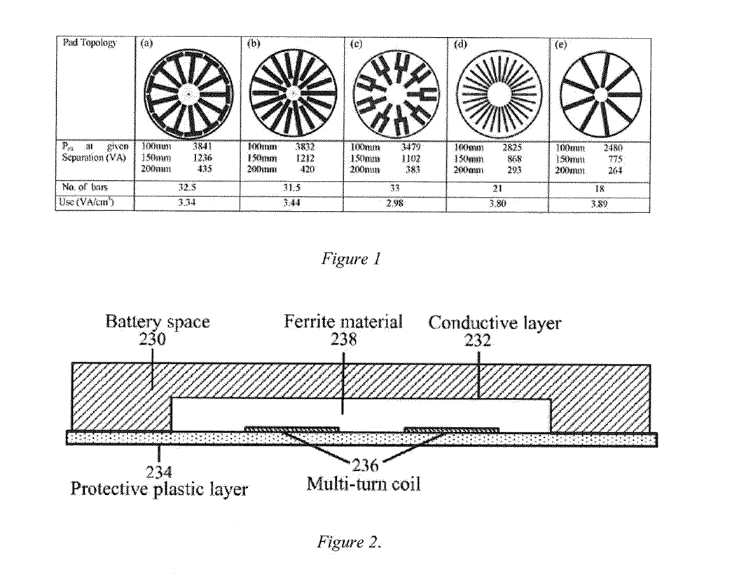

A method of transferring power at a large distance is claimed in [2]. FIG. 2 shows their arrangement of the magnetic material and winding. The core used is a circular pot core. The winding is a flat multi-turn coil. There is no mention about AC losses in the windings.

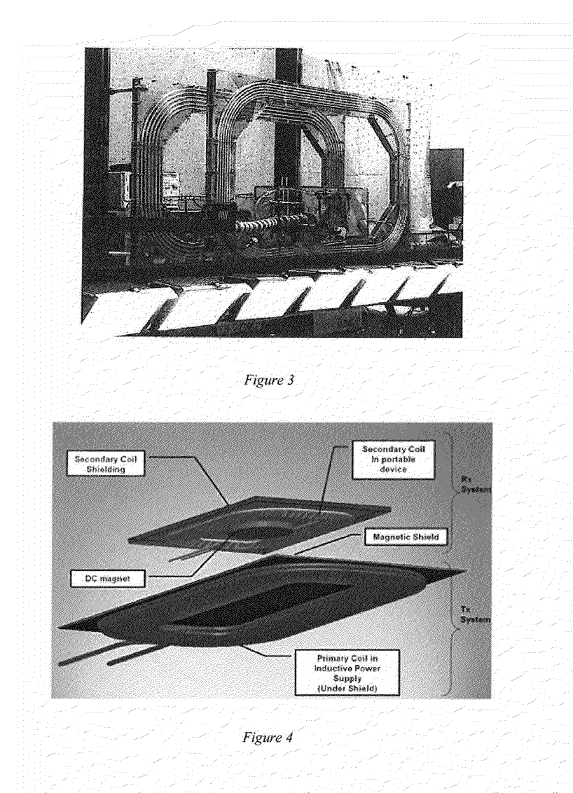

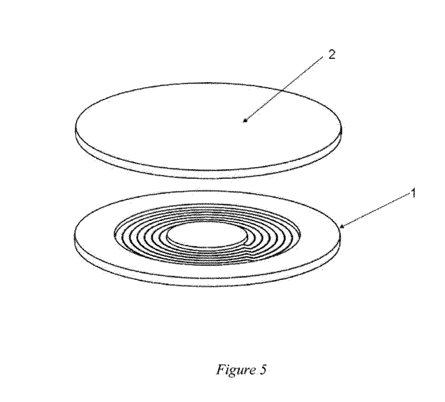

Careless wireless power transfer systems are investigated by John M. Miller, Matthew B. Scudiere, John W. McKeever, Cliff White in [3]. Coreless systems have to he large in size due to the fact that the lack of the magnetic core decreases the inductance. In order to compensate from a practical point of view the inside area of the coils has to be increased, or the number of turns has to be increased. Both solutions increase the DC resistance of the windings and as a result they increase the AC resistance of the windings. FIG. 3 shows the proposed transformer design from [3].

In [3] the authors acknowledge the fact that winding's AC losses play a significant role in the system's efficiency but they do not provide a solution to the problem.

Low power wireless power systems described in [4] use a ferrite material underneath the primary and secondary windings which increases the transformer's coupling. The use of a magnetic material also has the role of shielding the back side of the windings from the magnetic field. FIG. 4 shows the concept presented in [4]. Also in [4] the authors propose the use of a permanent magnet in the center of the winding in order to increase the coupling coefficient. The AC losses are not taken into consideration.

### DESCRIPTION OF THE PRESENT INVENTION

### First Embodiment

FIG. 5 shows a first magnetic structure according to the present invention. It comprises of a primary side 1 and a secondary side 2 which are identical in form and size. The primary and secondary include magnetic material and conductive windings. The windings can be made of regular copper wire or litz wire or they can be planar. Also the shape of the wire can be circular or rectangular. In the case of the planar winding configuration, the planar winding width can be designed with constant width per each turn or with a variable width per each turn.

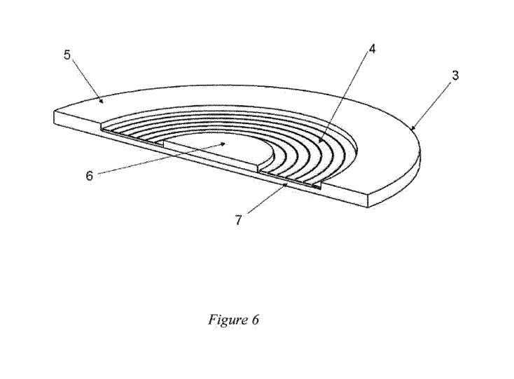

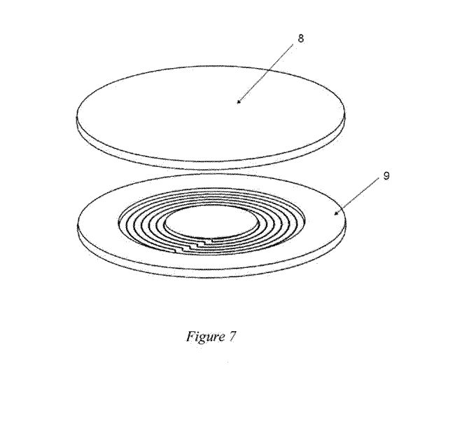

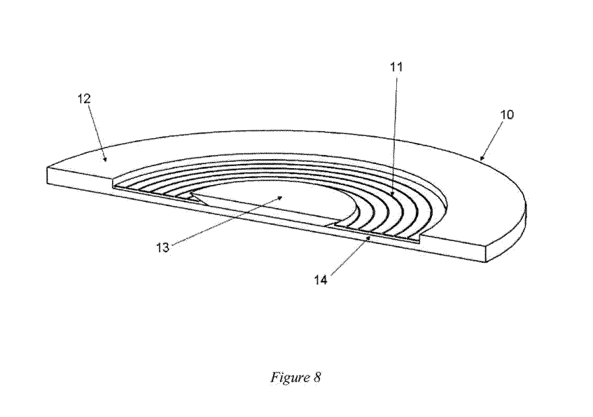

FIG. 6 shows a cross section of the primary side 3 of the magnetic structure. The novelty is the appearance of the magnetic outer edge 5. The ideal path of the magnetic field will he from the central primary post 6, through the air gap, through the central post of the secondary through the magnetic plate, through the secondary outer edge. through the air gap, through the primary magnetic edge 5, through the primary magnetic plate 7 and back through primary central post 6. This field lines path is followed by the desired magnetic mutual lines which form the mutual inductance.

The leakage lines path is from primary center post 6 through the air spaces between the primary turns 7, through the primary magnetic plate 7 and back through the central primary post 6. As a result the magnetic field lines are perpendicular to the copper and create high AC proximity effects in the windings.

The magnetic outer edge 5 has several advantages: it increases the primary inductance due to the increase in the total magnetic material size, it forces the leakage magnetic lines to be parallel with the winding and as a result reducing the winding's AC losses.

### Second Embodiment

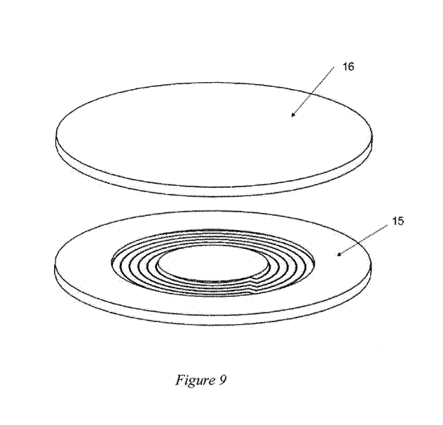

FIG. 7 shows a second magnetic structure according to the present invention. It comprises of a primary side 9 and a secondary side 8 which are identical in form and size. The primary and secondary include magnetic material and conductive windings. The windings can be made of regular copper wire or litz wire or they can be planar. Also the shape of the wire can be circular or rectangular. In the case of the planar winding configuration, the planar winding width can be designed with constant width per each turn or with a variable width per each turn.

FIG. 8 shows a cross section of the primary side 10 of the magnetic structure. The novelty is that the center post has an inverted trapezoidal shape or a hat shape. As a result, the winding is better shielded from the magnetic field. The leakage magnetic field becomes parallel with the winding. The reluctance between the center post 13 and the outer magnetic edge is decreased and more of the magnetic field lines are parallel with the winding.

The ideal path of the magnetic field is from primary center post 13 through the air gap, through the secondary center post, through the secondary magnetic plate, through the secondary magnetic edges, through the air gap, through the primary outer edges 12, through the primary magnetic plate 14, and back through the primary center post 13.

The area of the center post increases, the air gap reluctance is decreased. This compensates for the decrease of distance between the center post 13 and the outer edge 12 which is a leakage line path.

The trapezoidal hat concept can be applied to a variety of magnetic core shapes and can be combined with all the concepts presented in the current invention.

### Third Embodiment

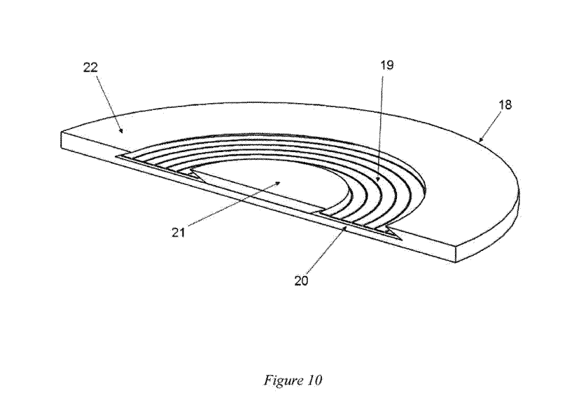

FIG. 9 shows a third magnetic structure according to the present invention. it comprises of a primary side 15 and a secondary side 16 which are identical in form and size. The primary and secondary include magnetic material and conductive windings. The windings can be made of regular copper wire or litz wire or they can be planar. Also the shape of the wire can be circular or rectangular. In the case of the planar winding configuration, the planar winding width can be designed with constant width per each turn or with a variable width per each turn.

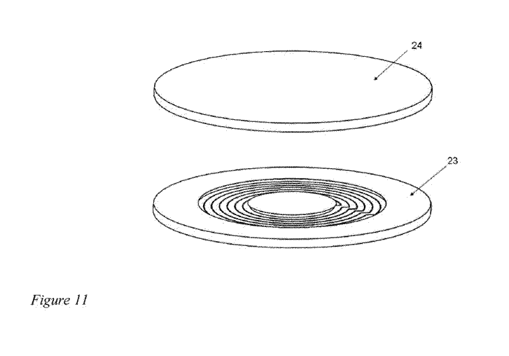

FIG. 10 shows a cross section of the primary side 18 of the magnetic structure. The novelty is that the center post has an inverted trapezoidal shape or a hat shape and the outer magnetic edge 22 has also a trapezoidal shape. As a result, the winding is better shielded from the magnetic field. The leakage magnetic field becomes parallel with the winding. The reluctance between the center post 21 and the outer magnetic edge 22 is decreased and more of the magnetic field lines are parallel with the winding.

The ideal path of the magnetic field is from primary center post 21 through the air gap, through the secondary center post, through the secondary magnetic plate, through the secondary magnetic edges, through the air gap, through the primary outer edges 22, through the primary magnetic plate 20, and back through the primary center post 21.

The area of the center post increases, the air gap reluctance is decreased. This compensates for the decrease of distance between the center post 21 and the outer edge 22 which is a leakage line path.

The trapezoidal hat concept can be applied to a variety of magnetic core shapes and can be combined with all the concepts presented in the current invention.

### Fourth Embodiment

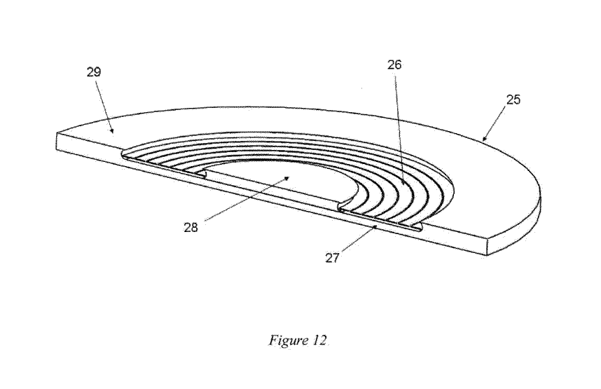

FIG. 11 shows a fourth magnetic structure according to the present invention. It comprises of a primary side 23 and a secondary side 24 which are identical in form and size. The primary and secondary include magnetic material and conductive windings. The windings can be made of regular copper wire or litz wire or they can be planar. Also the shape of the wire can be circular or rectangular. In the case of the planar winding configuration, the planar winding width can be designed with constant width per each turn or with a variable width per each turn.

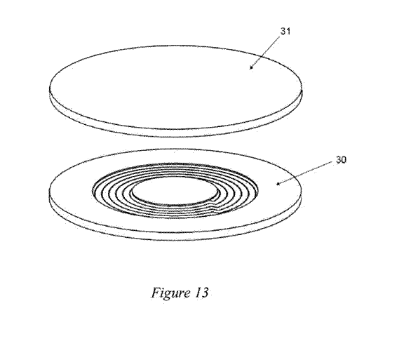

FIG. 12 shows a cross section of the primary side 25 of the magnetic structure.

The novelty is that the center post 28 has an inverted trapezoidal shape with rounded corners and the outer magnetic edge 29 has also a trapezoidal shape with round corners. As a result, the winding is better shielded from the magnetic field, The leakage magnetic field becomes parallel with the winding. The reluctance between the center post 28 and the outer magnetic edge 29 is decreased and more of the magnetic field lines are parallel with the winding.

The ideal path of the magnetic field is from primary center post 28 through the air gap, through the secondary center post, through the secondary magnetic plate, through the secondary magnetic edges, through the air gap, through the primary outer edges 29, through the primary magnetic plate 27, and back through the primary center post 28.

The area of the center post increases, the air gap reluctance is decreased. This compensates for the decrease of distance between the center post 28 and the outer edge 29 which is a leakage line path.

The trapezoidal hat concept with rounded corners can be applied to a variety of magnetic core shapes and can be combined with all the concepts presented in the current invention.

### Fifth Embodiment

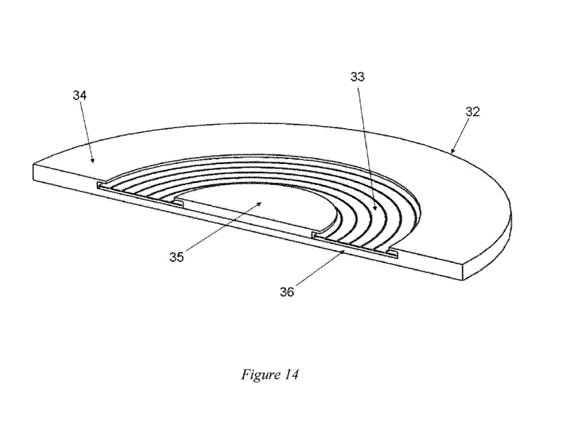

FIG. 13 shows a fifth magnetic structure according to the present invention. It comprises of a primary side 30 and a secondary side 31 which are identical in form and size. The primary and secondary include magnetic material and conductive windings. The windings can be made of regular copper wire or litz wire or they can be planar. Also the shape of the wire can be circular or rectangular. In the case of the planar winding configuration, the planar winding width can be designed with constant width per each turn or with a variable width per each turn.

FIG. 14 shows a cross section of the primary side 32 of the magnetic structure. The novelty is that the center post 35 has a t-shape and the outer magnetic edge 34 has also a t-shape. As a result, the winding is better shielded from the magnetic field. The leakage magnetic field becomes parallel with the winding. The reluctance between the center post 35 and the outer magnetic edge 34 is decreased and more of the magnetic field lines are parallel with the winding.

The ideal path of the magnetic field is from primary center post 235 through the air gap, through the secondary center post, through the secondary magnetic plate, through the secondary magnetic edges, through the air gap, through the primary outer edges 34, through the primary magnetic plate 36, and hack through the primary center post 35.

The area of the center post increases, the air gap reluctance is decreased. This compensates for the decrease of distance between the center post 35 and the outer edge 34 which is a leakage line path.

The t-shape hat concept can be applied to a variety of magnetic core shapes. and can be combined with all the concepts presented in the current invention.

### Sixth Embodiment

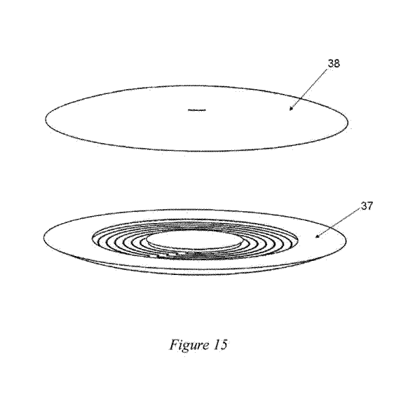

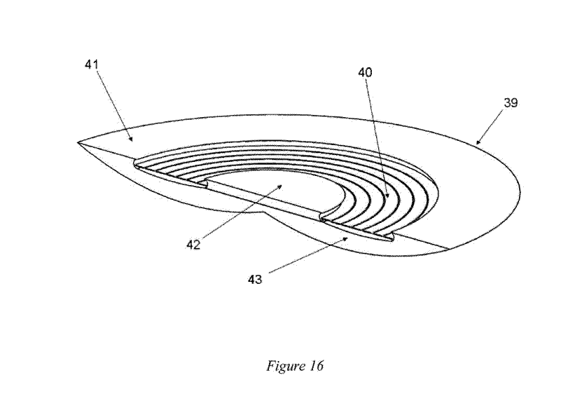

FIG. 15 shows a sixth magnetic structure according to the present invention. It comprises of a primary side 37 and a secondary side 38 which are identical in form and size. The primary and secondary include magnetic material and conductive windings. The windings can be made of regular copper wire or litz wire or they can be planar. Also the shape of the wire can be circular or rectangular. in the case of the planar winding configuration, the planar winding width can be designed with constant width per each turn or with a variable width per each turn.

FIG. 16 shows a cross section of the primary side 39 of the magnetic structure. The novelty is that the center post 42 has an inverted trapezoidal shape with rounded corners and the outer magnetic edge 41 has also an inverted trapezoidal shape with rounded corners. Also the ferrite base 43 has cuts in such way that it's magnetic reluctance is minimized. AS a result, the winding is better shielded from the magnetic field. The leakage magnetic field becomes parallel with the winding. The reluctance between the center post 42 and the outer magnetic edge 41 is decreased and more of the magnetic field lines are parallel with the winding.

The ideal path of the magnetic field is from primary center post 42 through the air gap, through the secondary center post, through the secondary magnetic plate, through the secondary magnetic edges, through the air gap, through the primary outer edges 41, through the primary magnetic plate 43. and back through the primary center post 42.

The area of the center post increases, the air gap reluctance is decreased. This compensates for the decrease of distance between the center post 42 and the outer edge 41 which is a leakage line path.

The trapezoidal shape with rounded corners and ferrite cuts concept can be applied to a variety of magnetic core shapes and can be combined with all the concepts presented in the current invention.

### SUMMARY

Thus, as seen from the foregoing description, one feature of the present invention is that the magnetic structures are configured to help minimize the winding's AC losses, improving the system's efficiency. Another feature is that the combination of different magnetic hats creates a shaping path for the magnetic field. Still another feature is that the magnetic hat concept can be applied to a variety of magnetic core shapes.

### REFERENCES

[1] Budhia, M. Boys, Covic, “Design and optimisation of Circular Magnetic Structures for Lumped Inductive Power Transfer Systems”, Power Electronics, IEEE Transactions on, Volume: 26, Issue: 11, Publication Year: 2011, Page(s): 3096-3108.
[2] US PATENT 20110254377A1.
[3] John M. Miller, Matthew B. Scudiere, John W. McKeever, Cliff White, “Wireless Power Transfer” Oak Ridge National Laboratory's Power Electronics Symposium Tennessee,
[4] A. E. Umenei, J. Schwannecke, S. Velpula, D. Baarman, “Novel Method for Selective Non-linear Fluxguide Switching for Contactless Inductive Power Transfer”, Fulton Innovation, Ada Mich., USA.

1. Novel magnetic structures configured to help minimize the AC tosses in the windings of the magnetic structures, and improving the system's efficiency.

2. A new technique of shaping the magnetic cores of magnetic structures to minimize the winding's AC losses.

3. A magnetic “hat” concept intended to channel the magnetic field of a magnets structure to be parallel with the winding of the magnetic structure.
